(19) United States
(12) Patent Application Publication
(10) Pub. No.: US 2009/0002101 A1
(43) Pub. Date: Jan. 1, 2009

(54) HIGH-PASS FILTER

(75) Inventor: Satoshi MOCHIZUKI, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/134,383

(22) Filed: Jun. 6, 2008

(30) Foreign Application Priority Data
Jun. 26, 2007 (JP) 2007-167486

(51) Int. Cl. H01P 1/203

(52) U.S. Cl. 333/204

(57) ABSTRACT

A high frequency filter for filtering a frequency component from a high frequency signal includes a capacitor and a branch line. The capacitor may be disposed in series to a transmission line. The transmission line transmits the high frequency signal. The capacitor performs as capacitive component to the high frequency signal. The branch line may intersect the transmission line. The branch line may include, but is not limited to, a capacitive portion and an inductive portion. The capacitive portion performs as capacitive component to the high frequency signal. The inductive portion performs as inductive component to the high frequency signal.

### BACKGROUND OF THE INVENTION

1. Field of the Invention

The present invention generally relates to a high-pass filter that filters a high frequency signal so as to pass high frequency components of that signal, while to attenuate or eliminate lower frequency components than a predetermined cutoff frequency.

Priority is claimed on Japanese Patent Application No. 2007-167486, filed Jun. 26, 2007, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

FIG. 11 is a circuit diagram illustrating a typical example of a conventional high-pass filter that is designed with a distributed constant. A conventional high-pass filter 100 shown in FIG. 11 can be realized by a micro-strip line. The conventional high-pass filter 100 includes an input 101, an output 102, and a transmission line 103 between the input 101 and the output 102. The conventional high-pass filter 100 further includes first and second capacitors 104 and 105 that are connected in series to the transmission line 103. In other words, the transmission line 103 has the series connection of the first and second capacitors 104 and 105. The conventional high-pass filter 100 furthermore includes first, second and third inductors 106, 107 and 108 that are connected in parallel and shunt to the transmission line 103. The first inductor 106 is connected in parallel or shunt to the transmission line 103 between the input 101 and the first capacitor 104. The second inductor 107 is connected in parallel or shunt to the transmission line 103 between the first and second capacitors 104 and 105. The third inductor 108 is connected in parallel or shunt to the transmission line 103 between the output 102 and the second capacitor 105. The conventional high-pass filter 100 performs as a fifth-order filter.

A high frequency signal is input into the input 101. The high frequency signal includes low frequency components and high frequency components. The low frequency components are lower in frequency than a cut-off frequency that is given by the conventional high-pass filter 100. A majority of the low frequency components is cut off by the first and second capacitors 104 and 105, while it is drawn to the first to third inductors 106, 107 and 108. Most of the high frequency components passes through the first and second capacitors 104 and 105 and then appears at the output 102. The conventional high-pass filter 100 filters the high frequency signal so as to pass the high frequency components, while to eliminate or block the low frequency components.

FIG. 12 is a diagram showing transmission characteristic curves L10 and L20 of Chebyshev filter and Butterworth filter, respectively. The transmission characteristic curve L1 of the Chebyshev filter has ripples Ar in the pass-band. The transmission characteristic curve L10 of the Chebyshev filter has a steeper attenuation slope than the attenuation slope of the Butterworth filter around the cut-off frequency fc. The transmission characteristic curve L20 of the Butterworth filter has general flatness in the pass-band. The transmission characteristic curve L20 of the Butterworth filter has the gentler attenuation slope than that of the Chebyshev filter. The attenuation slope of the transmission characteristic curve L20 of the Butterworth filter is −6 dB/oct which means that the transmission is attenuated by 6dB as the frequency increases two times.

Japanese Unexamined Patent Application, First Publication, No. 6-97701 discloses a conventional filter circuit.

In recent years, there has needed to scale down a variety of electronic devices or electronic components. In general, mobile phones deal with high frequency signals. Such mobile phones need to be reduced in its external sizes or dimensions and in its weight. The mobile phones include a high frequency filter which also needs to be reduced in its external sizes or dimensions. When Chebyshev filter or Butterworth filter can be used as a high frequency filter, an approximated size of the filter can be presumed from the design specification. Using a substrate that has a high dielectric needs to scale down the filter.

The high frequency filter needs to have the steepness of attenuation slope of the transmission curve. The steepness of attenuation slope can be obtained by increasing the order of a filter. Increasing the order of a filter increases the size or dimension of the filter. Otherwise, a substrate with a high dielectric needs to be used to obtain the steepness of attenuation slope, while increasing the order of the filter. Using the substrate with a high dielectric may cause impedance-mismatch with circuits over other substrate. Using the substrate with a high dielectric may cause that the pattern width of the circuit over the high dielectric substrate is extremely narrowed, thereby making it difficult to form the circuit. In addition, the high dielectric substrate is generally expensive, resulting in the increased cost for the high frequency filter. In light of the integration of the high frequency filter, it is not preferable to use the high dielectric substrate for the high frequency filter separately from the other substrate on which other circuits are formed.

In view of the above, it will be apparent to those skilled in the art from this disclosure that there exists a need for an improved high frequency filter. This invention addresses this need in the art as well as other needs, which will become apparent to those skilled in the art from this disclosure.

### SUMMARY OF THE INVENTION

Accordingly, it is a primary object of the present invention to provide an improved high frequency filter.

It is another object of the present invention to provide a high frequency filter that does not need to use any high dielectric substrate.

It is a further object of the present invention to provide a high frequency filter that can reduce the cost thereof.

It is a still further object of the present invention to provide a high frequency filter that can be reduced in its size.

It is yet a further object of the present invention to provide a high frequency filter that has a steep attenuation property.

In accordance with a first aspect of the present invention, a high frequency filter for filtering a frequency component from a high frequency signal may include, but is not limited to, a capacitor and a branch line. The capacitor may be disposed in series to a transmission line. The transmission line transmits the high frequency signal. The capacitor performs as capacitive component to the high frequency signal. The branch line may intersect the transmission line. The branch line may include, but is not limited to, a capacitive portion and an inductive portion. The capacitive portion performs as capacitive component to the high frequency signal. The inductive portion performs as inductive component to the high frequency signal.

A high frequency signal is input into the transmission line. The high frequency signal transmits through the capacitor. A portion of the high frequency signal then propagates on the branch line and returns to the transmission line so that the portion is coupled with the remaining portion of the high frequency signal being transmitting on the transmission line.

In some cases, the inductive portion of the branch line may include, but is not limited to, a first pattern. The first pattern is narrower in width than the transmission line. The first pattern extends in a cross-direction to the transmission line.

In some cases, the capacitive portion of the branch line may include, but is not limited to, a second pattern that is wider in width than the first pattern. The second pattern extends in a cross-direction to the transmission line.

In some cases, the capacitive portion of the branch line may include, but is not limited to, a plurality of third patterns that are electromagnetically coupled to each other. The third patterns extend in a cross-direction to the transmission line.

In some cases, the branch line may extend from at least one side of the transmission line in a cross-direction to the transmission line.

In some cases, the high frequency filter may further include, but is not limited to, an inductor. The inductor may be disposed in series to the transmission line. The inductor performs inductive component to the high frequency signal.

In some cases, the inductor may include, but is not limited to, a fourth pattern. The fourth pattern may be narrower in width than the transmission line. The fourth pattern may be aligned to the transmission line.

In some cases, the branch line may extend from the fourth pattern.

In some cases, the capacitor may include, but is not limited to, a chip capacitor.

In some cases, the capacitor may include, but is not limited to, a fifth pattern that partially overlaps the transmission line in plan view. The fifth pattern may be electromagnetically coupled to the transmission line to form a capacitive component between the fifth pattern and the transmission line.

The high frequency filter for filtering a frequency component from a high frequency signal may include, but is not limited to, a capacitor and a branch line. The capacitor may be disposed in series to a transmission line. The transmission line transmits the high frequency signal. The capacitor performs as capacitive component to the high frequency signal. The branch line may intersect the transmission line. The branch line may include, but is not limited to, a capacitive portion and an inductive portion. The capacitive portion performs as capacitive component to the high frequency signal. The inductive portion performs as inductive component to the high frequency signal. The high frequency filter can have a steep attenuation property. The high frequency filter can be scaled down. The high frequency filter does not need to use a high dielectric substrate. The high frequency filter having a steep attenuation property and a small size can be realized without using any high dielectric substrate.

These and other objects, features, aspects, and advantages of the present invention will become apparent to those skilled in the art from the following detailed descriptions taken in conjunction with the accompanying drawings, illustrating the embodiments of the present invention.

### BRIEF DESCRIPTION OF THE DRAWINGS

Referring now to the attached drawings which form a part of this original disclosure:

FIG. 1 is a plain view illustrating a high frequency filter in accordance with a first embodiment of the present invention;

FIG. 2 is a cross sectional elevation view illustrating the high frequency filter, taken along an A-A line of FIG. 1;

FIG. 3 is a diagram illustrating variation of transmission over frequency to show transmission property of the high frequency filter of FIG. 1;

FIG. 4 is a plain view illustrating a high frequency filter in accordance with a second embodiment of the present invention;

FIG. 5 is a diagram illustrating variation of transmission over frequency to show transmission property of the high frequency filter of FIG. 4;

FIG. 6 is a plain view illustrating an example of the modification to the high frequency filter in accordance with the second embodiment of the present invention;

FIG. 7A is a plain view illustrating a modified example of the high frequency filter in accordance with the first embodiment of the present invention;

FIG. 7B is a plain view illustrating another modified example of the high frequency filter in accordance with the first embodiment of the present invention;

FIG. 8A is a plain view illustrating still another modified example of the high frequency filter in accordance with the first embodiment of the present invention;

FIG. 8B is a plain view illustrating yet another modified example of the high frequency filter in accordance with the first embodiment of the present invention;

FIG. 9 is a plain view illustrating other modified example of the high frequency filter in accordance with the first embodiment of the present invention;

FIG. 10A is a plain view illustrating other modified example of the high frequency filter in accordance with the first embodiment of the present invention;

FIG. 10B is a cross sectional elevation view illustrating the other modified example of the high frequency filter, taken along a B-B line of FIG. 10A;

FIG. 11 is a circuit diagram illustrating a typical example of a conventional high-pass filter that is designed with a distributed constant; and

FIG. 12 is a diagram showing transmission characteristic curves L10 and L20 of Chebyshev filter and Butterworth filter, respectively.

### DETAILED DESCRIPTION OF THE INVENTION

Selected embodiments of the present invention will now be described with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

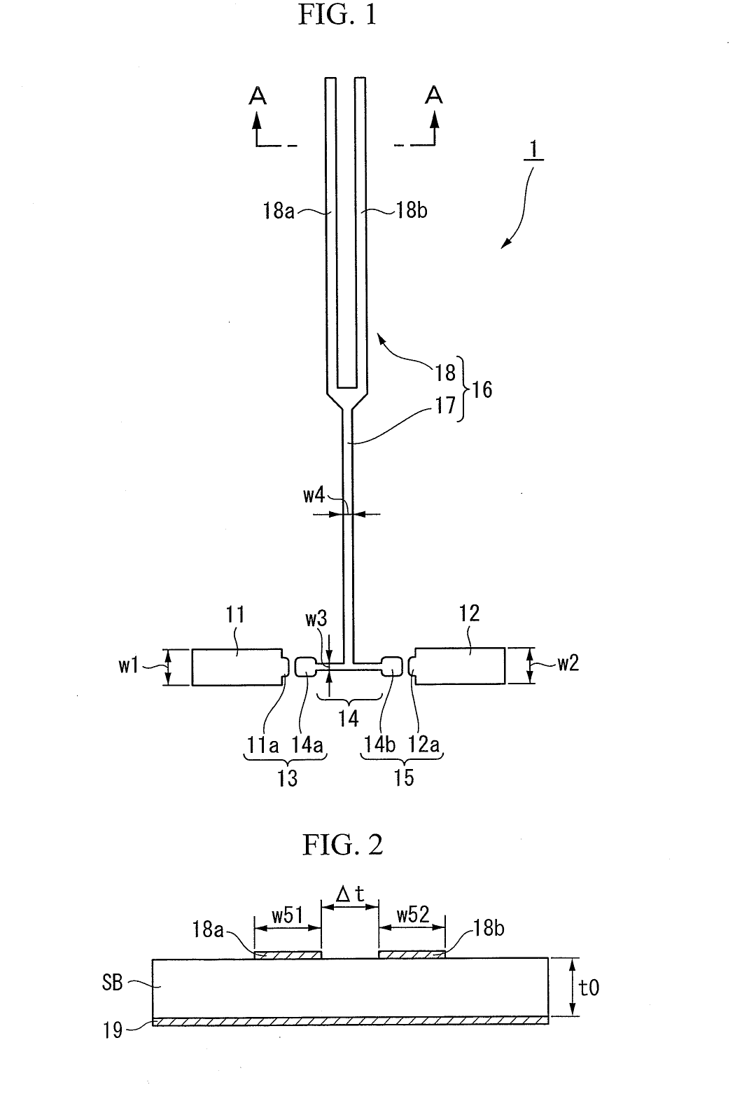

FIG. 1 is a plain view illustrating a high frequency filter in accordance with a first embodiment of the present invention. FIG. 2 is a cross sectional elevation view illustrating the high frequency filter, taken along an A-A line of FIG. 1. In some cases, a high frequency filter 1 can be realized by using a microstripline. The following descriptions will be made for the high frequency filter 1 using the microstripline. A high frequency filter 1 can be disposed on a dielectric substrate SB. The high frequency filter 1 may include, but is not limited to, a transmission line and a filtering portion. The transmission line allows transmission of a high frequency signal. The transmission line may include, but is not limited to, input and output lines 11 and 12, and first and second capacitors 13 and 15. The filtering portion may include, but is not limited to, an inductor 14 and a branch-line 16.

The first and second capacitors 13 and 15 can perform as a transmission line for a high frequency signal. The inductor 14 is disposed between the first and second capacitors 13 and 15. The first and second capacitors 13 and 15 are disposed between the input and output lines 11 and 12. The input and output lines 11 and 12 extend in a direction along which the high frequency signal transmits. This direction will hereinafter be referred to as a transmission direction. The branch-line 16 extends from the inductor 14 in a direction different from the transmission direction. In a typical case, the branch-line 16 extends from the inductor 14 in the direction perpendicular to the transmission direction along which the input and output lines 11 and 12 extend. This direction will hereinafter be referred to as a perpendicular direction.

The input line 11 can be configured to receive an input of the high frequency signal. The output line 12 can be configured to output a filtered signal. The high frequency signal is filtered by the high frequency filter and a specific frequency component can pass and output from the output line 12, while other frequency components being eliminated or attenuated by the high frequency filter. The input and output lines 11 and 12 are aligned in the transmission direction. The input and output lines 11 and 12 have widths w1 and w2. In some cases, the input and output lines 11 and 12 may be deigned to have the widths w1 and w2 of about 1 mm and the impedance of 50Ω. The input and output lines 11 and 12 are electrically coupled to each other through the first and second capacitors 13 and 15 and the inductor 14.

The first and second capacitors 13 and 15 are connected in series to the input and output lines 11 and 12. The first and second capacitors 13 and 15 perform as capacitive components for the high frequency signal. The input and output lines 11 and 12 have extension portions 11a and 12a that extend toward the inductor 14. The inductor 14 has first and second expanding portions 14a and 14b at its opposing ends. The first expanding portion 14a is separated by a predetermined first gap from the extension portion 11a of the input line 11. The second expanding portion 14b is separated by a predetermined second gap from the extension portion 12a of the output line 12. The first capacitor 13 includes the extension portion 11a of the input line 11 and the first expanding portion 14a of the inductor 14. The second capacitor 15 includes the extension portion 12a of the input line 12 and the second expanding portion 14b of the inductor 14. The sizes and widths of each of the extension portions 11a and 12a and each of the first and second expanding portions 14a and 14b can be adapted in accordance with the intended properties of the high frequency filter 1.

The inductor 14 is disposed between the first and second capacitors 13 and 15, while the inductor 14 is disposed in series to the input and output lines 11 and 12, so that the inductor 14 performs as an inductive component for the high frequency signal. The inductor 14 has a width w3 which is narrower than the widths W1 and W2 of the input and output lines 11 and 12. The inductor 14 may be realized by a straight pattern which extends in the transmission direction along which the input and output lines 11 and 12 extend. In other words, the inductor 14 is aligned to the input and output lines 11 and 12. The width and length of the inductor 14 can be adapted in accordance with the intended performance of the high frequency filter 1.

The branch-line 16 extends from one side of the inductor 14 in the perpendicular direction that is perpendicular to the transmission direction along which the input and output lines 11 and 12 extend. In some cases, the branch-line 16 may include an inductive portion 17 and a capacitive portion 18. The inductive portion 17 performs as an inductive component for the high frequency signal. The capacitive portion 18 performs as a capacitive component for the high frequency signal. The provision of the inductive portion 17 and the capacitive portion 18 as the branch-line 16 may allow the high frequency filter to possess steep attenuation properties and to have small size. In other cases, the branch-line 16 may include a plurality of inductive portions 17 and a single capacitive portion 18. In still other cases, the branch-line 16 may include a single inductive portion 17 and a plurality of capacitive portions 18. In yet other cases, the branch-line 16 may include a plurality of inductive portions 17 and a plurality of capacitive portions 18.

The inductive portion 17 is narrower in width than the input line 11 and the output line 12. Typically, the inductive portion 17 has a width w4 which is narrower than the widths w1 and w2 of the input and output lines 11 and 12. In some cases, the inductive portion 17 may have a straight line pattern (first pattern) which extends from the inductor 14 in the perpendicular direction. The inductive portion 17 with the straight line pattern has opposing first and second ends. The first end is connected to the inductor 14. The second end is connected to the capacitive portion 18. The inductive portion 17 can be adjusted in its width and length in accordance with the intended properties of the high frequency filter 1.

In some cases, the capacitive portion 18 may include a connecting portion and first and second straight line patterns 18a and 18b. The connecting portion of the capacitive portion 18 connects the first and second straight line patterns 18a and 18b to the second end of the inductive portion 17. The first and second straight line patterns 18a and 18b, which are spatially separated by a gap At from each other, extend from the connecting portion in the perpendicular direction and in parallel to each other. The first and second straight line patterns 18a and 18b perform as open stubs. A pair of the first and second straight line patterns 18a and 18b forms a third pattern. In general, the capacitive portion 18 may include the connecting portion and a plurality of open stubs. The plurality of open stubs may be two or more open stubs. The first and second straight line patterns 18a and 18b may have optional widths. In some cases, the first and second straight line patterns 18a and 18b may have widths w5 1 and w52 which are approximately the same as the width w4 of the inductive portion 17.

The plural open stubs are electromagnetically coupled to each other, even the plural open stubs are spatially separated from each other. The first and second straight line patterns 18a and 18b are electromagnetically coupled to each other, even the first and second straight line patterns 18a and 18b are spatially separated from each other. The high frequency signal propagates through the first and second straight line patterns 18a and 18b that perform as the plural open stubs, while a first component of the high frequency signal that is propagating through the first straight line pattern 18a partially further propagates through the gap At to the second straight line pattern 18b, and a second component of the high frequency signal that is propagating through the second straight line pattern 18b partially further propagates through the gap Δt to the first straight line pattern 18a.

Electromagnetic coupling between the plural open stubs such as the first and second straight line patterns 18a and 18b can provide increased capacitance of the capacitive portion 18.

The high frequency filter 1 may be disposed on a dielectric substrate SB. In some cases, the high frequency filter 1 may be disposed on a first surface of the dielectric substrate SB as shown in FIG. 2. A ground pattern 19 can be disposed on the second surface of the dielectric substrate SB. The ground pattern 19 has a ground potential. The dielectric substrate SB has a thickness to. If the gap or distance Δt between the first and second straight line patterns 18a and 18b is not more than three times of the thickness t0 of the dielectric substrate SB, then the first and second straight line patterns 18a and 18b would be regarded to be electromagnetically coupled to each other.

In some cases, the high frequency circuit may need to be designed so that the first and second straight line patterns 18a and 18b are electromagnetically isolated. In order to electromagnetically isolate the first and second straight line patterns 18a and 18b, the high frequency circuit can be designed so that the distance Δt between the first and second straight line patterns 18a and 18b is greater than three times of the thickness t0 of the dielectric substrate SB, thereby suppressing propagations of the high frequency signal between the first and second straight line patterns 18a and 18b. When the dielectric substrate SB has a thickness t0 of 0.5 millimeters, the distance Δt between the first and second straight line patterns 18a and 18b is greater than 1.5 millimeters so as to suppress propagations of the high frequency signal between the first and second straight line patterns 18a and 18b, thereby electromagnetically isolating the first and second straight line patterns 18a and 18b.

In other cases, the high frequency circuit may need to be designed so that the first and second straight line patterns 18a and 18b are electromagnetically coupled. In order to electromagnetically couple the first and second straight line patterns 18a and 18b, the high frequency circuit can be designed so that the distance Δt between the first and second straight line patterns 18a and 18b is not greater than three times of the thickness t0 of the dielectric substrate SB, thereby allowing propagations of the high frequency signal between the first and second straight line patterns 18a and 18b. If the distance At between the first and second straight line patterns 18a and 18b is not greater than three times of the thickness t0 of the dielectric substrate SB, then this allows propagations of the high frequency signal between the first and second straight line patterns 18a and 18b, so that the first and second straight line patterns 18a and 18b are electromagnetically coupled.

Consequently, if the distance Δt between the first and second straight line patterns 18a and 18b is not greater than three times of the thickness t0 of the dielectric substrate SB, then the first and second straight line patterns 18a and 18b are electromagnetically coupled. The coupling efficiency k indicates the degree of electromagnetic coupling between the first and second straight line patterns 18a and 18b. In order to increase the coupling efficiency k, it is effective that the distance Δt between the first and second straight line patterns 18a and 18b is not greater than the thickness t0 of the dielectric substrate SB. If the distance Δt between the first and second straight line patterns 18a and 18b is not greater than the thickness t0 of the dielectric substrate SB, then it is effective to increase the coupling efficiency k and electrically couple the first and second straight line patterns 18a and 18b. Provision of the first and second straight line patterns 18a and 18b for the capacitive portion 18 can make it easy to adjust the capacitive component of the capacitive portion 18.

For designing the branch-line 16, the issue of which one of the inductive component of the inductive portion 17 and the capacitive component of the capacitive portion 18 dominates another can be determined in accordance with the filtering property that needs to be realized. If the cut off frequency of the high frequency filter 1 needs to be high relatively, then the branch-line 16 can preferably be designed so that the capacitive component of the capacitive portion 18 dominates the inductive component of the inductive portion 17. If the cut off frequency of the high frequency filter 1 needs to be low relatively, then the branch-line 16 can preferably be designed so that the inductive component of the inductive portion 17 dominates the capacitive component of the capacitive portion 18. In order to realize steep attenuation property of the high frequency filter 1, the small size, and the low manufacturing cost, it would be more important that the branch-line 16 includes the inductive component and the capacitive component, but it is not so important that which one of the inductive component of the inductive portion 17 and the capacitive component of the capacitive portion 18 dominates another.

The dielectric substrate SB on which the high frequency filter 1 is formed can be realized by any dielectric substances having low or high dielectric constant. The dielectric substrates being high in dielectric constant may be expensive. In light of cost reduction, the dielectric substrate SB can be realized by a dielectric substance having low dielectric constant. Typically, the inexpensive dielectric substrate SB may be a dielectric substrate having dielectric constant of about 3.4 such as a glass epoxy substrate. Over the dielectric substrate SB, the branch-line 16 has a first dimension of approximately a few millimeters in the transmission direction, and a second dimension of approximately a several tens millimeters in the perpendicular direction.

In the above typical case, the high frequency filter 1 has two capacitors, for example, the first and second capacitors 13 and 15 that are disposed in series on the high frequency signal transmission line. Namely, the high frequency filter 1 includes the high frequency signal transmission line which further includes the input and output lines 11 and 12, the first and second capacitors 13 and 15, and the inductor 14. It is possible as a modification that the high frequency filter 1 has a single capacitor that is disposed in series on the high frequency signal transmission line. Namely, the high frequency filter 1 includes the high frequency signal transmission line which may further include the input and output lines 11 and 12, the single capacitor, and the inductor 14.

The high frequency signal is input into the input line 11. The high frequency signal propagates through the first capacitor 13 to the inductor 14. The inductor 14 splits the high frequency signal into first and second split-signals. The first split-signal propagates through the inductor 14 to the second capacitor 15. The second split-signal propagates on the branch-line 16. The second split-signal propagates through the inductive portion 17 to the capacitive portion 18. The capacitive portion 18 includes the first and second straight line patterns 18a and 18b that perform as open stubs. The second split-signal propagates on the first and second straight line patterns 18a and 18b. Parts of the components of the second split-signal propagating on the first and second straight line patterns 18a and 18b may also propagate between the first and second straight line patterns 18a and 18b. Then, the second split-signal is reflected by the capacitive portion 18. The reflected second split-signal propagates through the inductive portion 17 to the inductor 14. At the inductor, the reflected second split-signal is combined with the first-split signal, thereby generating a filtered high frequency signal. The combined high frequency signal propagates through the second capacitor 15 to the output line 15.

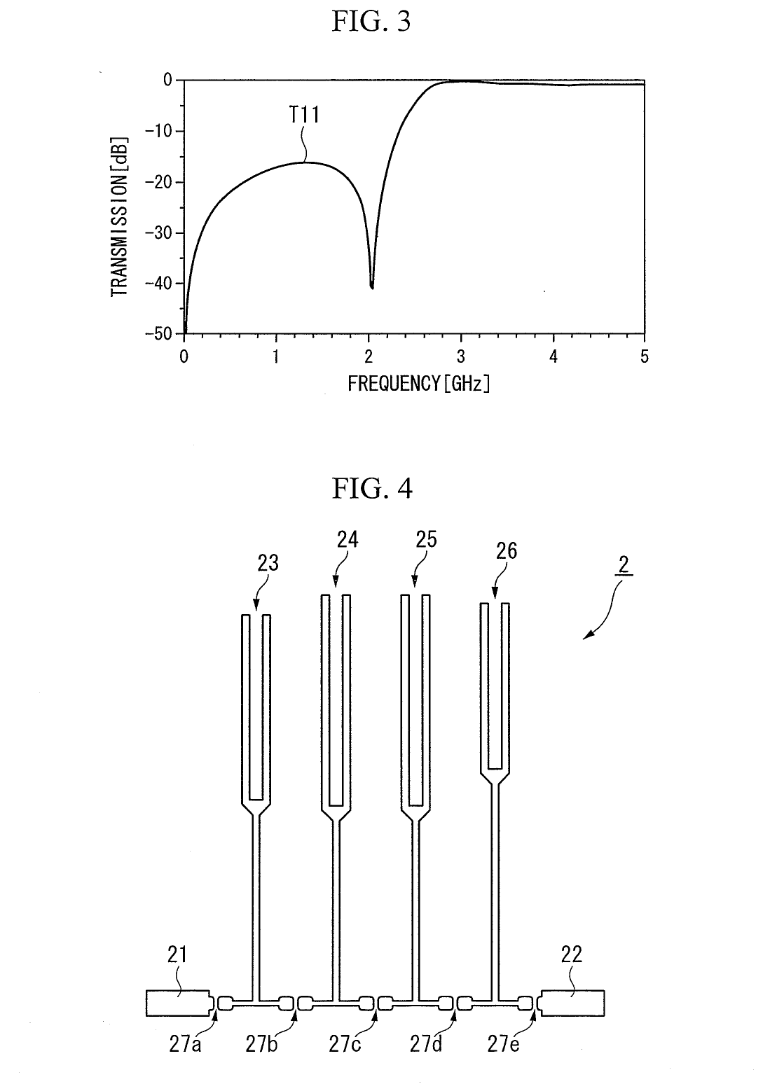

FIG. 3 is a diagram illustrating variation of transmission over frequency to show transmission property of the high frequency filter of FIG. 1. The transmission curve T11 approximately shows transmission property of the high frequency filter 1, provided that the transmission curve T11 accurately shows the frequency property of the scattering parameter (S-parameter) S21 of a four-terminal circuit that is used as an equivalent circuit for the high frequency filter 1.

With reference to FIG. 3, the transmission is almost 0 [dB] in a high frequency range of not lower than 3 GHz. As the frequency is decreased from 2.8 GHz to 2.6 GHz, the transmission is gradually decreased. As the frequency is decreased from 2.6 GHz to 2.0 GHz, the transmission is steeply decreased. As the frequency is decreased from 2.0 GHz to 1.8 GHz, the transmission is steeply increased. As the frequency is decreased from 1.8 GHz to 1.0 GHz, the transmission is maintained about −20 [dB]. As the frequency is decreased from 1.0 GHz to 0.4 GHz, the transmission is gradually decreased. As the frequency is decreased from 0.4 GHz to 0 GHz, the transmission is steeply decreased again. The transmission curve T11 shows that the high frequency filter 1 has the transmission property for performing as a high pass filter. The transmission property shows a steep attenuation in the range of 2.0 GHz to 2.6 GHz. The attenuation gradient is large in the range of 2.0 GHz to 2.6 GHz. FIG. 3 demonstrates that, without using the high dielectric substrate, it is possible to realize the high frequency filter 1 that has the steep attenuation filtering property and small size and at a low manufacturing cost.

### Second Embodiment

FIG. 4 is a plain view illustrating a high frequency filter in accordance with a second embodiment of the present invention. A high frequency filter 2 can be disposed on a dielectric substrate that is not illustrated. The dielectric substrate may be the same as the dielectric substrate shown in FIG. 2. The high frequency filter 2 may include, but is not limited to, a transmission line and first, second, third and fourth filtering portions 23, 24, 25, and 26. The transmission line allows transmission of a high frequency signal. The transmission line may include, but is not limited to, input and output lines 21 and 22, and first, second, third, fourth and fifth capacitors 27a, 27b, 27c, 27d and 27e. The filtering portion may include, but is not limited to, an inductor 14 and a branch-line 16. Each of the first to fourth filtering portions 23, 24, 25, and 26 performs as the same or similar function to what has been described with reference to FIG. 1. The first to fourth filtering portions 23, 24, 25, and 26 are disposed between the input and output lines 21 and 22. Each of the first to fourth filtering portions 23, 24, 25, and 26 may have the same or similar structure as what has been described with reference to FIG. 1. Each of the first to fourth filtering portions 23, 24, 25, and 26 may include, but is not limited to, an inductor and a branch-line. Each branch line may include, but is not limited to, an inductive portion and a capacitive portion.

The first to fifth capacitors 27a, 27b, 27c, 27d and 27e can perform as a transmission line for a high frequency signal. The inductor of the first filtering portion 23 is disposed between the first and second capacitors 27a and 27b. The first capacitor 27a is disposed between the input line 21 and the inductor of the first filtering portion 23. The inductor of the second filtering portion 24 is disposed between the second and third capacitors 27b and 27c. The second capacitor 27b is disposed between the inductor of the first filtering portion 23 and the inductor of the second filtering portion 24. The inductor of the third filtering portion 25 is disposed between the third and fourth capacitors 27c and 27d. The third capacitor 27c is disposed between the inductor of the second filtering portion 24 and the inductor of the third filtering portion 25. The inductor of the fourth filtering portion 26 is disposed between the fourth and fifth capacitors 27d and 27e. The fourth capacitor 27d is disposed between the inductor of the third filtering portion 25 and the inductor of the fourth filtering portion 26. The fifth capacitor 27e is disposed between the inductor of the fourth filtering portion 26 and the output line 22.

The first to fourth filtering portions 23, 24, 25, and 26 are disposed so that the capacitive portions of the branch-lines of adjacent two of the first to fourth filtering portions 23, 24, 25, and 26 are electromagnetically separated from each other. Namely, the capacitive portions of the branch-lines of adjacent two of the first to fourth filtering portions 23, 24, 25, and 26 are spatially distanced by a gap that is greater than three times of the thickness t0 of the dielectric substrate SB.

The input and output lines 21 and 22, the first to fifth capacitors 27a, 27b, 27c, 27d and 27e and the inductors of the first to fourth filtering portions 23, 24, 25, and 26 are aligned in the transmission direction as shown in FIG. 4. The first to fifth capacitors 27a, 27b, 27c, 27d and 27e are disposed in series between the input and output lines 21 and 22. Each of the first to fifth capacitors 27a, 27b, 27c, 27d and 27e can be realized by a spatial gap between conductive portions. The input and output lines 21 and 22 have extension portions that extend toward the inductor 14. Each of the inductors of the first to fourth filtering portions 23, 24, 25, and 26 has first and second expanding portions at its opposing ends similarly to what is described with reference to FIG. 1.

The first capacitor 27a can be formed by a first gap between the extension portion of the input line 21 and the first expanding portion of the inductor of the first filtering portion 23. The second capacitor 27b can be formed by a second gap between the second expanding portion of the inductor of the first filtering portion 23 and the first expanding portion of the inductor of the second filtering portion 24. The third capacitor 27c can be formed by a third gap between the second expanding portion of the inductor of the second filtering portion 24 and the first expanding portion of the inductor of the third filtering portion 25. The fourth capacitor 27d can be formed by a fourth gap between the second expanding portion of the inductor of the third filtering portion 25 and the first expanding portion of the inductor of the fourth filtering portion 26. The fifth capacitor 27e can be formed by a fifth gap between the second expanding portion of the inductor of the fourth filtering portion 26 and the extension portion of the output line 22.

The high frequency filter 2 can be formed on the same dielectric substrate as that described with reference to FIG. 2. Namely, the high frequency filter 2 can be formed on an inexpensive dielectric substance that has a low dielectric constant such as a glass epoxy substrate. Over the dielectric substrate SB, each of the first to fourth filtering portions 23, 24, 25, and 26 has a first dimension of approximately a ten millimeters in the transmission direction, and a second dimension of approximately a several tens millimeters in the perpendicular direction.

With reference closely to FIG. 4, the first to fourth filtering portions 23, 24, 25, and 26 may have different patterns. A set of the first to fourth filtering portions 23, 24, 25, and 26 may form a filter pattern that is asymmetrical with reference to the transmission direction. In some cases, the inductive portion of the fourth filtering portion 26 may be longer than those of the first to third filtering portions 23, 24, and 25. The capacitive portion of the fourth filtering portion 26 may be shorter than those of the first to third filtering portions 23, 24, and 25. The inductive portion of the first filtering portion 23 may be longer than those of the second and third filtering portions 24 and 25, but shorter than that of the fourth filtering portion 26. The capacitive portion of the first filtering portion 23 may be shorter than those of the second and third filtering portions 24 and 25, but longer than that of the fourth filtering portion 26. The second and third filtering portions 24 and 25 may have the same pattern as each other. The reason why the capacitive portion of the fourth filtering portion 26 may be shorter than those of the first, second and third filtering portions 23, 24 and 25 is as follows. The high frequency filter 2 has a property that can be represented by approximately an elliptic function. In order to obtain the required property, it is preferable that the high frequency filter 2 is asymmetrical in the transmission direction. Notwithstanding, it is possible that the high frequency filter 2 is symmetrical in the transmission direction provided that the required property can be obtained.

The high frequency signal is input into the input line 21. The high frequency signal propagates through the first capacitor 27a to the inductor of the first filtering portion 23. The inductor of the first filtering portion 23 splits the high frequency signal into first and second split-signals. The first split-signal propagates through the inductor of the first filtering portion 23 to the second capacitor 27b. The second split-signal propagates on the branch-line of the first filtering portion 23. Namely, the second split-signal propagates through the inductive portion of the first filtering portion 23 to the capacitive portion thereof. The capacitive portion of the first filtering portion 23 includes the first and second straight line patterns that perform as open stubs. The second split-signal propagates on the first and second straight line patterns. Parts of the components of the second split-signal propagating on the first and second straight line patterns may also propagate between the first and second straight line patterns. Then, the second split-signal is reflected by the capacitive portion of the first filtering portion 23. The reflected second split-signal propagates through the inductive portion to the inductor. At the inductor, the reflected second split-signal is combined with the first split-signal, thereby generating a first filtered high frequency signal.

The first filtered high frequency signal propagates through the second capacitor 27b to the inductor of the second filtering portion 24. The inductor of the second filtering portion 24 splits the first filtered high frequency signal into third and fourth split-signals. The third split-signal propagates through the inductor of the second filtering portion 24 to the third capacitor 27c. The fourth split-signal propagates on the branch-line of the second filtering portion 24. Namely, the fourth split-signal propagates through the inductive portion of the second filtering portion 24 to the capacitive portion thereof. The capacitive portion of the second filtering portion 24 includes the third and fourth straight line patterns that perform as open stubs. The fourth split-signal propagates on the third and fourth straight line patterns. Parts of the components of the fourth split-signal propagating on the third and fourth straight line patterns may also propagate between the third and fourth straight line patterns. Then, the fourth split-signal is reflected by the capacitive portion of the second filtering portion 24. The reflected fourth split-signal propagates through the inductive portion to the inductor. At the inductor, the reflected fourth split-signal is combined with the third split-signal, thereby generating a second filtered high frequency signal.

The second filtered high frequency signal propagates through the third capacitor 27c to the inductor of the third filtering portion 25. The inductor of the third filtering portion 25 splits the second filtered high frequency signal into fifth and sixth split-signals. The fifth split-signal propagates through the inductor of the third filtering portion 25 to the fourth capacitor 27d. The sixth split-signal propagates on the branch-line of the third filtering portion 25. Namely, the sixth split-signal propagates through the inductive portion of the third filtering portion 25 to the capacitive portion thereof. The capacitive portion of the third filtering portion 25 includes the fifth and sixth straight line patterns that perform as open stubs. The sixth split-signal propagates on the fifth and sixth straight line patterns. Parts of the components of the sixth split-signal propagating on the fifth and sixth straight line patterns may also propagate between the fifth and sixth straight line patterns. Then, the sixth split-signal is reflected by the capacitive portion of the third filtering portion 25. The reflected sixth split-signal propagates through the inductive portion to the inductor. At the inductor, the reflected sixth split-signal is combined with the fifth split-signal, thereby generating a third filtered high frequency signal.

The third filtered high frequency signal propagates through the fourth capacitor 27d to the inductor of the fourth filtering portion 26. The inductor of the fourth filtering portion 26 splits the third filtered high frequency signal into seventh and eighth split-signals. The seventh split-signal propagates through the inductor of the fourth filtering portion 26 to the fifth capacitor 27e. The eighth split-signal propagates on the branch-line of the fourth filtering portion 26. Namely, the eighth split-signal propagates through the inductive portion of the fourth filtering portion 26 to the capacitive portion thereof. The capacitive portion of the fourth filtering portion 26 includes the seventh and eighth straight line patterns that perform as open stubs. The eighth split-signal propagates on the seventh and eighth straight line patterns. Parts of the components of the eighth split-signal propagating on the seventh and eighth straight line patterns may also propagate between the seventh and eighth straight line patterns. Then, the eighth split-signal is reflected by the capacitive portion of the fourth filtering portion 26. The reflected eighth split-signal propagates through the inductive portion to the inductor. At the inductor, the reflected eighth split-signal is combined with the seventh split-signal, thereby generating a fourth filtered high frequency signal. The fourth filtered high frequency signal performs as a filtered output signal. The filtered output signal propagates through the fifth capacitor 27e to the output line 22. The filtered output signal is then output from the output line 22.

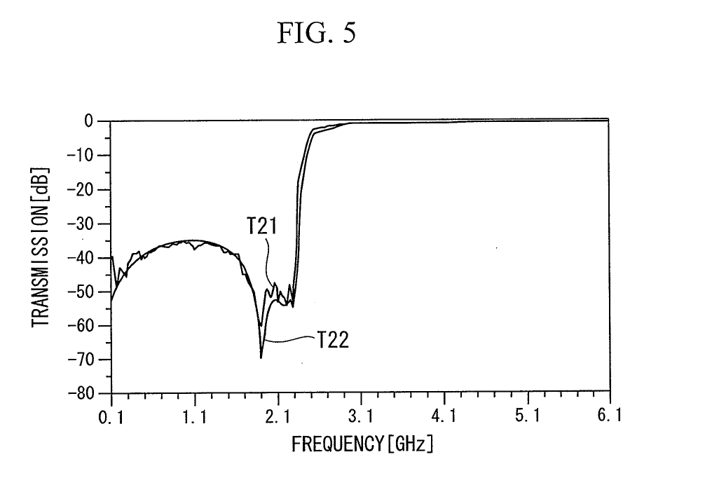

FIG. 5 is a diagram illustrating variation of transmission over frequency to show transmission property of the high frequency filter of FIG. 4. The transmission curve T21 approximately shows measured transmission property of the high frequency filter 2, provided that the transmission curve T21 accurately shows the frequency property of the scattering parameter (S-parameter) S21 of a four-terminal circuit that is used as an equivalent circuit for the high frequency filter 2. The transmission curve T22 approximately shows simulated transmission property of the high frequency filter 2, provided that the transmission curve T21 accurately shows the frequency property of the scattering parameter (S-parameter) S21 of the four-terminal circuit that is used as an equivalent circuit for the high frequency filter 2.

With reference to FIG. 5, the transmission is almost 0 [dB] in a high frequency range of not lower than 3.1 GHz. The cut-off frequency is 2.9 GHz when the transmission is −3 dB. As the frequency decreases from 2.5 GHz to 2.3 GHz, the transmission decreases steeply. As the frequency decreases from 2.3 GHz to 2.1 GHz, the transmission is maintained about −50 [dB]. As the frequency decreases from 2.1 GHz to 1.9 GHz, the transmission decreases to −70 dB. As the frequency decreases from 1.9 GHz to 1.3 GHz, the transmission increases to −740 dB. As the frequency decreases from 1.3 GHz to 0.1 GHz, the transmission is maintained in the range of about −35 [dB] to −50 [dB]. The transmission curves T21 and T22 each show that the high frequency filter 1 has the transmission property for performing as a high pass filter. The transmission property shows a steep attenuation in the range of 2.3 GHz to 2.5 GHz. The attenuation gradient is large in the range of 2.3 GHz to 2.5 GHz. The transmission curves T21 and T22 are almost identical to each other. FIG. 5 demonstrates that the high frequency filter 2 has the transmission property that performs as a high pass filter. FIG. 5 also demonstrates that the measured value of the transmission over the frequency is almost identical to the simulated value thereof. In the low frequency band of not more than 2 GHz, the transmission of the high pass filter 2 of FIG. 5 is maintained lower than that of the high pass filter 1 of FIG. 1.

If the high frequency filter 2 having the attenuation property shown in FIG. 5 is realized by the Chebyshev filter, then a multi-stage configuration of not less than the twenty first order needs to realize it, resulting in the increase in the size of the Chebyshev filter. If the high frequency filter 2 having the attenuation property shown in FIG. 5 is realized by using a chip, then variation of the property of the chip and its parasitic capacitance may make it difficult to obtain the intended property of the filter shown in FIG. 5. FIG. 5 also demonstrates that, without using the high dielectric substrate, it is possible to realize the high frequency filter 2 that has the steep attenuation filtering property and small size and at a low manufacturing cost. In the low frequency band of not more than 2 GHz, the high frequency filter 2 of FIG. 4 is maintained lower in transmission than the high frequency filter 1 of FIG. 1.

It is possible to modify the first to fourth filtering portions 23, 24, 25, and 26 of the high pass filter 2. Increasing the lengths of the inductive portions of the branch-lines of the first to fourth filtering portions 23, 24, 25, and 26 may in general decrease the cut off frequency. Increasing the width of the inductive portions of the branch-lines of the first to fourth filtering portions 23, 24, 25, and 26 may in general decrease the cut off frequency.

### First Modification:

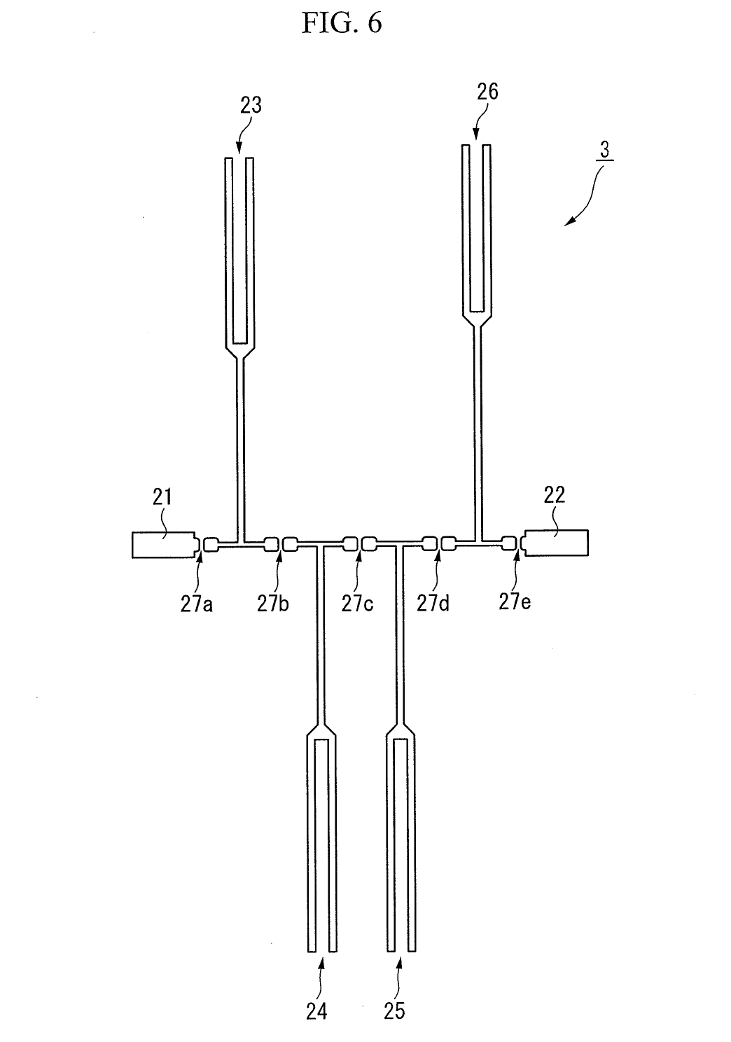

FIG. 6 is a plain view illustrating an example of the modification to the high frequency filter in accordance with the second embodiment of the present invention. As shown in FIG. 4, the high frequency filter 2 has the first to fourth filtering portions 23 to 26 that have the branch-lines disposed in the first side of the transmission line. No branch-line is disposed in the second side of the transmission line. A high pass filter 3 shown in FIG. 6 is different from the high pass filter 2 shown in FIG. 4. At least one of the first and fourth filtering portions 23 and 26 is disposed in the first side of the transmission line, while the other of the first and fourth filtering portions 23and 26 is disposed in the second side of the transmission line.

In some cases, the first and fourth filtering portions 23 and 26 may extend in the first side of the transmission line, while the second and third filtering portions 24 and 25 may extend in the second side of the transmission line. Namely, the first and fourth filtering portions 23 and 26 may extend in the opposing direction to the second and third filtering portions 24 and 25. In other cases, any one of the first and fourth filtering portions 23 and 26 is disposed in the first side of the transmission line, while the remainders of the first and fourth filtering portions 23 and 26 are disposed in the second side of the transmission line. In still other cases, any one of the first and fourth filtering portions 23 and 26 is disposed in the second side of the transmission line, while the remainders of the first and fourth filtering portions 23 and 26 are disposed in the first side of the transmission line. The number of the filtering portions being disposed in the first side of the transmission line may be either identical to or different from the number of the filtering portions being disposed in the second side of the transmission line.

### Second Modification:

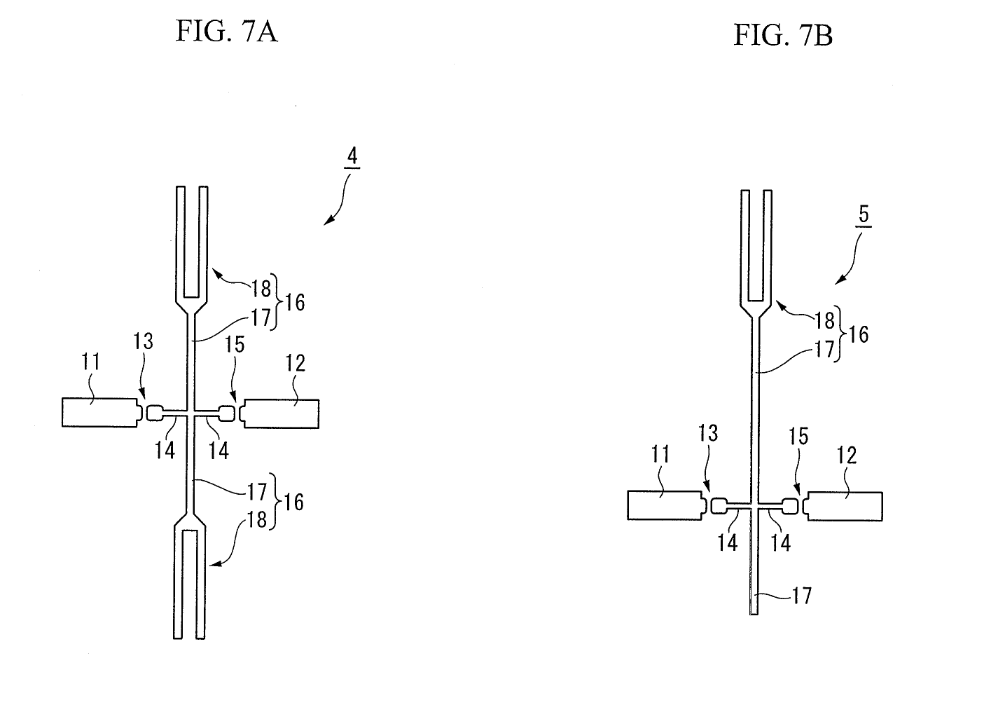

FIG. 7A is a plain view illustrating a modified example of the high frequency filter in accordance with the first embodiment of the present invention. As shown in FIG. 1, the high frequency filter 1 includes the filtering portion that has the single branch-line 16. The branch-line 16 is disposed in the first side of the transmission line. The branch-line 16 extends from the inductor 14 in the perpendicular direction to the transmission direction. A high frequency filter 4 may include, but is not limited to, a transmission line and a filtering portion. The transmission line may include, but is not limited to, the input and output lines 11 and 12, and the first and second capacitors 13 and 15. The transmission line of FIG. 7A may be the same as the transmission line of FIG. 1. The filtering portion may include, but is not limited to, the inductor 14 and a pair of branch-lines 16. The inductor 14 of FIG. 7A may be the same as the inductor 14 of FIG. 1. The paired branch-lines 16 extend from the inductor 14 in the opposing directions which are perpendicular to the transmission direction.

In some cases, the paired branch-lines 16 may each include the inductive portion 17 and the capacitive portion 18. The inductive portion 17 of FIG. 7A may be the same as the inductive portion 17 of FIG. 1. The capacitive portion 18 of FIG. 7A may be the same as the capacitive portion 18 of FIG. 1. The pair of branch-lines 16 extending in the both sides of the transmission line can increase the flexibility of layout. In some cases, the pattern of the filtering portion of FIG. 7A may be symmetrical to a center axis of the transmission line. Namely, the paired branch-lines 16 may be aligned to each other to form the symmetry of the pattern of the filtering portion. In other cases, the paired branch-lines 16 may extend in the opposing directions but to form the asymmetry of the pattern of the filtering portion. Namely, the paired branch-lines 16 may not be aligned to each other.

### Third Modification:

FIG. 7B is a plain view illustrating another modified example of the high frequency filter in accordance with the first embodiment of the present invention. As shown in FIG. 1, the high frequency filter 1 includes the filtering portion that has the single branch-line 16. The branch-line 16 is disposed in the first side of the transmission line. The branch-line 16 extends from the inductor 14 in the direction that is perpendicular to the transmission direction. A high frequency filter 5 may include, but is not limited to, a transmission line and a filtering portion. The transmission line may include, but is not limited to, the input and output lines 11 and 12, and the first and second capacitors 13 and 15. The transmission line of FIG. 7B may be the same as the transmission line of FIG. 1. The filtering portion may include, but is not limited to, the inductor 14, a branch-line 16 and an inductive portion 17. The inductor 14 of FIG. 7B may be the same as the inductor 14 of FIG. 1. The branch-line 16 extends from the inductor 14 in the first side of the transmission line. The branch-line 16 may include the inductive portion 17 and the capacitive portion 18.

The branch-line 16 of FIG. 7B may be the same as the branch-line 16 of FIG. 1. The inductive portion 17 is disposed in the second side of the transmission line. The inductive portion 17 extends from the inductor 14 in the opposite direction to the branch-line 16. The inductive portion 17 in the second side of the transmission line may be adjusted in length relative to the inductive portion 17 in the first side of the transmission line. None of the capacitive portion 18 is disposed in the second side of the transmission line. The branch-line 16 extending in the first side of the transmission line in combination with the inductive portion 17 extending in the second side of the transmission line can increase the flexibility of layout. As a further modification, it is possible that the inductive portion 17 is disposed in the first side of the transmission line and the branch-line 16 is disposed in the second side of the transmission line.

### Fourth Modification:

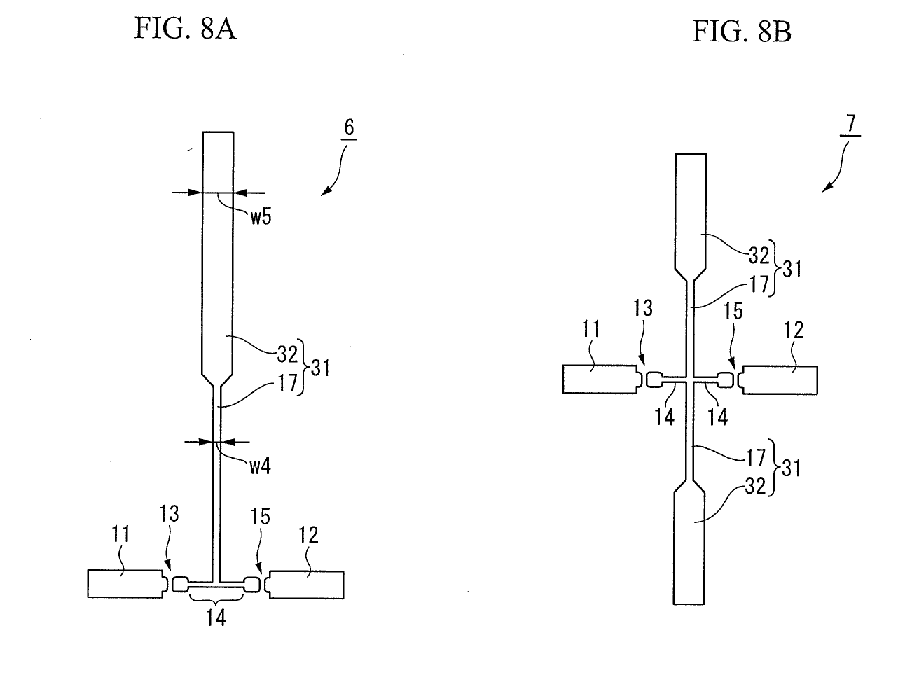

FIG. 8A is a plain view illustrating still another modified example of the high frequency filter in accordance with the first embodiment of the present invention. As shown in FIG. 1, the high frequency filter 1 includes the filtering portion that has the single branch-line 16. The branch-line 16 is disposed in the first side of the transmission line. The branch-line 16 extends from the inductor 14 in the direction that is perpendicular to the transmission direction. A high frequency filter 6 may include, but is not limited to, a transmission line and a filtering portion. The transmission line may include, but is not limited to, the input and output lines 11 and 12, and the first and second capacitors 13 and 15. The transmission line of FIG. 8A may be the same as the transmission line of FIG. 1. The filtering portion may include, but is not limited to, the inductor 14, and a branch-line 31. The inductor 14 of FIG. 8A may be the same as the inductor 14 of FIG. 1. The branch-line 31 extends from the inductor 14 in the first side of the transmission line. The branch-line 31 may include the inductive portion 17 and a capacitive portion 32. The branch-line 31 of FIG. 8A is different from the branch-line 16 of FIG. 1. The inductive portion 17 of FIG. 8A is the same as the inductive portion of FIG. 1. The capacitive portion 32 of FIG. 8A is different from the capacitive portion 18 of FIG. 1.

The capacitive portion of FIG. 1 includes the connecting portion and the first and second straight line patterns 18a and 18b. The capacitive portion of FIG. 1 performs as open stubs. The capacitive portion 32 of FIG. 8A includes a wide straight line pattern that has a width “w5” that is wider than the width “w4” of the inductive portion 17. The capacitive portion 32 extends from the inductive portion 17 in the direction that is perpendicular to the transmission direction. The capacitive portion 32 is aligned to the inductive portion 17. The capacitive portion 32 of the wide straight line pattern performs as another open stub. The width “w5” of the capacitive portion 32 is optional as long as the width “w5” of the capacitive portion 32 is wider than the width “w4” of the inductive portion 17. The branch-line 31 includes the inductive portion 17 and the capacitive portion 32. The provision of the inductive portion 17 and the capacitive portion 32 as the branch-line 31 may allow the high frequency filter 6 to possess steep attenuation properties and to have small size and low manufacturing cost. In order to realize steep attenuation property of the high frequency filter 6, the small size, and the low manufacturing cost, it would be important that the branch-line 32 includes the inductive component and the capacitive component.

### Fifth Modification:

FIG. 8B is a plain view illustrating yet another modified example of the high frequency filter in accordance with the first embodiment of the present invention. As shown in FIG. 1, the high frequency filter 1 includes the filtering portion that has the single branch-line 16. The branch-line 16 is disposed in the first side of the transmission line. The branch-line 16 extends from the inductor 14 in the direction that is perpendicular to the transmission direction. A high frequency filter 7 may include, but is not limited to, a transmission line and a filtering portion. The transmission line may include, but is not limited to, the input and output lines 11 and 12, and the first and second capacitors 13 and 15. The transmission line of FIG. 8B may be the same as the transmission line of FIG. 1. The filtering portion may include, but is not limited to, the inductor 14, and a pair of branch-lines 31. The inductor 14 of FIG. 8B may be the same as the inductor 14 of FIG. 1. The paired branch-lines 31 extend from the inductor 14 in the both sides of the transmission line. The paired branch-lines 31 are disposed in the both sides of the transmission line. The paired branch-lines 31 are aligned to each other.

The branch-lines 31 may each include the inductive portion 17 and the capacitive portion 32. The branch-lines 31 of FIG. 8B are each different from the branch-line 16 of FIG. 1. The inductive portion 17 of FIG. 8B is the same as the inductive portion of FIG. 1. The capacitive portions 32 of FIG. 8B are each different from the capacitive portion 18 of FIG. 1. The capacitive portion 18 of FIG. 1 includes the connecting portion and the first and second straight line patterns 18a and 18b. The capacitive portion of FIG. 1 performs as open stubs. The capacitive portion 32 of FIG. 8B includes a wide straight line pattern that is wider than the width of the inductive portion 17. The capacitive portion 32 extends from the inductive portion 17 in the direction that is perpendicular to the transmission direction. The capacitive portion 32 is aligned to the inductive portion 17. The capacitive portion 32 of the wide straight line pattern performs as another open stub. The width of the capacitive portion 32 is optional as long as the width of the capacitive portion 32 is wider than the width of the inductive portion 17. The branch-lines 31 each include the inductive portion 17 and the capacitive portion 32. The paired branch-lines 31 are disposed in the both sides of the transmission line to increase the flexibility of layout.

In some cases, the pattern of the filtering portion of FIG. 8B may be symmetrical to a center axis of the transmission line. Namely, the paired branch-lines 31 may be aligned to each other to form the symmetry of the pattern of the filtering portion. In other cases, the paired branch-lines 31 may extend in the opposing directions but to form the asymmetry of the pattern of the filtering portion. Namely, the paired branch-lines 32 may not be aligned to each other. The provision of the inductive portion 17 and the capacitive portion 32 as the branch-line 31 may allow the high frequency filter 7 to possess steep attenuation properties and to have small size and low manufacturing cost. In order to realize steep attenuation property of the high frequency filter 7, the small size, and the low manufacturing cost, it would be important that the branch-lines 32 each include the inductive component and the capacitive component.

### Sixth Modification:

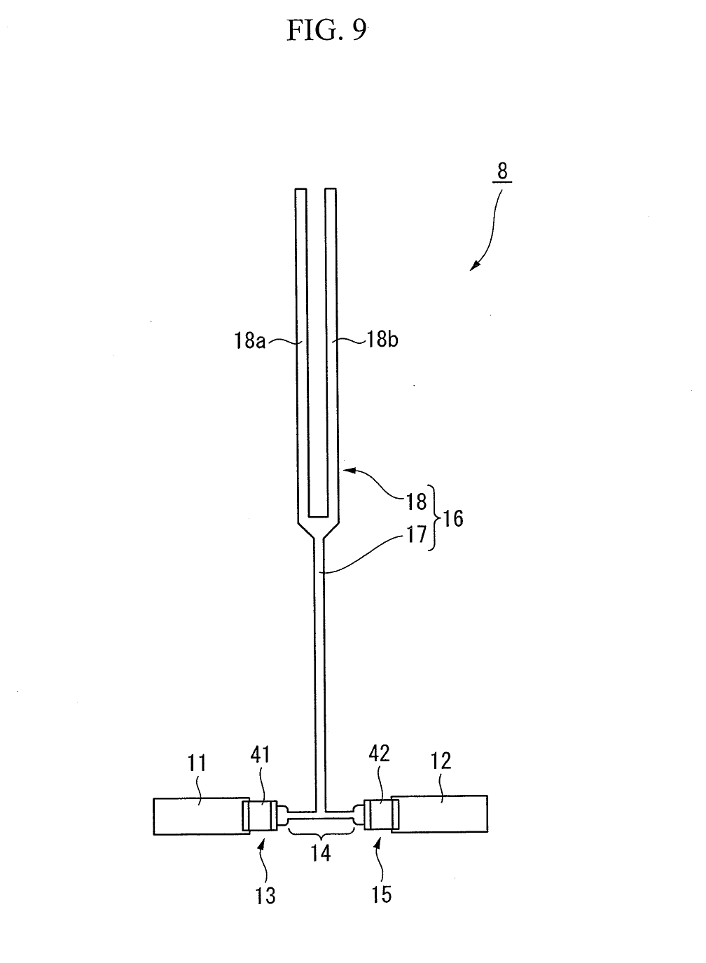

FIG. 9 is a plain view illustrating other modified example of the high frequency filter in accordance with the first embodiment of the present invention. As shown in FIG. 1, the high frequency filter 1 includes the filtering portion that has the single branch-line 16 and the transmission line. The transmission line includes the input and output lines 11 and 12 and first and second capacitors 13 and 15 which are formed by spatial gaps. A high frequency filter 8 may include, but is not limited to, a transmission line and a filtering portion. The transmission line may include, but is not limited to, the input and output lines 11 and 12, and first and second capacitors 13 and 15. The first and second capacitors 13 and 15 shown in FIG. 9 are different from the first and second capacitors 13 and 15 shown in FIG. 1. In some cases, the first and second capacitors 13 and 15 shown in FIG. 9 are formed by first and second chip capacitors 41 and 42, respectively. The first chip capacitor 41 has a first electrode which is connected to the extension portion 11a of the input line 11, and a second electrode which is connected to the first expanding portion of the inductor 14. The second chip capacitor 42 has a first electrode which is connected to the second expanding portion of the inductor 14 and a second electrode which is connected to the extension portion 12a of the output line 12. The first and second chip capacitors 41 and 42 increase the capacitances of the first and second capacitors 13 and 15, respectively.

### Seventh Modification:

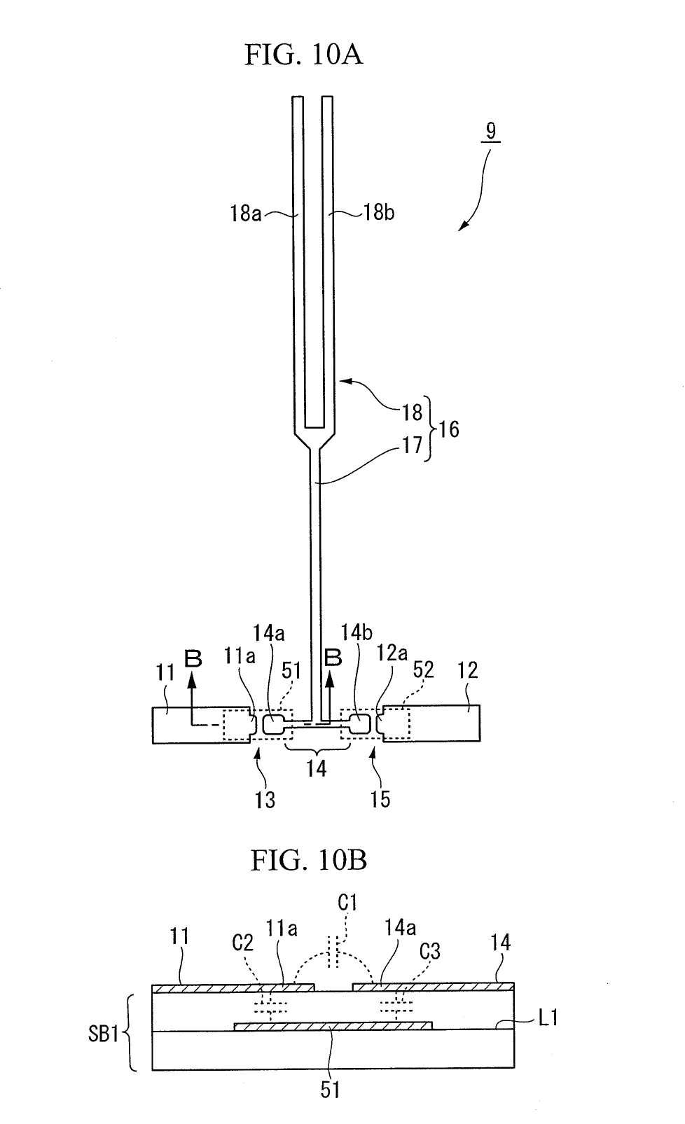

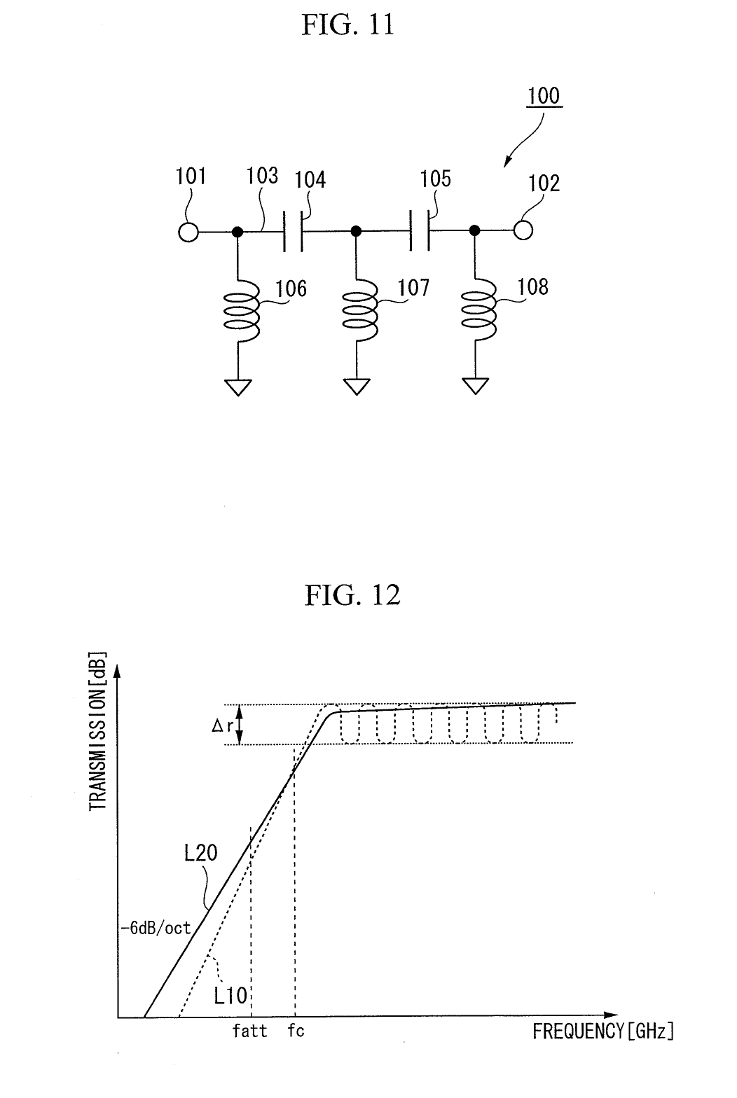

FIG. 10A is a plain view illustrating other modified example of the high frequency filter in accordance with the first embodiment of the present invention. FIG. 10B is a cross sectional elevation view illustrating the other modified example of the high frequency filter, taken along a B-B line of FIG. 10A. As shown in FIG. 1, the high frequency filter 1 includes the filtering portion and the transmission line. The filtering portion includes the single branch-line 16. The transmission line includes the input and output lines 11 and 12 and first and second capacitors 13 and 15 which are formed by spatial gaps. A high frequency filter 9 can be formed using a multi-layered substrate SB1. The multi-layered substrate SB1 may have a plurality of levels at which conductors can be formed. In some cases, the multi-layered substrate SB1 may have first and second levels, wherein the first level is at an intermediate level of the multi-layered substrate SB1, and the second level is at an upper surface level of the multi-layered substrate SB1.

The high frequency filter 9 may include, but is not limited to, a transmission line and a filtering portion. The transmission line may include, but is not limited to, the input and output lines 11 and 12, and first and second capacitors 13 and 15. The filtering portion may include, but is not limited to, an inductor 14 and a branch-line 16. The branch-line 16 may include, but is not limited to, an inductive portion 17 and a capacitive portion 18. The first capacitor 13 includes the extension portion 11a of the input line 11, the first expanding portion 14a of the inductor 14 and a first conductive pattern 51. The second capacitor 15 includes the extension portion 12a of the input line 12, the second expanding portion 14b of the inductor 14 and a second conductive pattern 52.

The first and second conductive patterns 51 and 52 are formed in the multi-layered substrate SB1 but at a level which is deeper than the surface level of the multi-layered substrate SB1. The first and second conductive patterns 51 and 52 can be formed at the first level of the multi-layered substrate SB1, wherein the first level is deeper than the second level which corresponds to the upper surface level. In other wards, the first and second conductive patterns 51 and 52 are buried in the multi-layered substrate SB1. The input and output lines 11 and 12, the inductor 14, and the branch-line 16 are formed at the second level or the upper surface level of the multi-layered substrate SB1. The input and output lines 11 and 12, the inductor 14, and the branch-line 16 are formed over the surface of the multi-layered substrate SB1.

As shown in FIG. 10B, the first conductive pattern 51 is disposed so that in plan view a part of the first conductive pattern 51 overlaps at least a part of the input line 11, while another part of the first conductive pattern 51 overlaps at least a part of the first expanding portion 14a of the inductor 14. The input line 11 is spatially separated from the inductor 14 by a spatial gap, thereby forming a first capacitance C1 between them. Namely, the first capacitance C1 is formed by an electromagnetic coupling between the extension portion 11a of the input line 11 and the first expanding portion 14a of the inductor 14. The input line 11 is separated from the first conductive pattern 51 by the upper layer of the multi-layered substrate SB1, thereby forming a second capacitance C2 between them. Namely, the second capacitance C2 is formed by an electromagnetic coupling between the input line 11 and the first conductive pattern 51. The inductor 14 is separated from the first conductive pattern 51 by the upper layer of the multi-layered substrate SB1, thereby forming a third capacitance C3 between them. Namely, the third capacitance C3 is formed by an electromagnetic coupling between the inductor 14 and the first conductive pattern 51. The first capacitor 13 has the first, second and third capacitances C1, C2 and C3.

Similarly, the second conductive pattern 52 is disposed so that in plan view a part of the second conductive pattern 52 overlaps at least a part of the output line 12, while another part of the second conductive pattern 52 overlaps at least a part of the second expanding portion 14b of the inductor 14. The output line 12 is spatially separated from the inductor 14 by a spatial gap, thereby forming a fourth capacitance between them. Namely, the fourth capacitance is formed by an electromagnetic coupling between the extension portion 12a of the output line 12 and the second expanding portion 14b of the inductor 14. The output line 12 is separated from the second conductive pattern 52 by the upper layer of the multi-layered substrate SB1, thereby forming a fifth capacitance between them. Namely, the fifth capacitance is formed by an electromagnetic coupling between the output line 12 and the second conductive pattern 52. The inductor 14 is separated from the second conductive pattern 52 by the upper layer of the multi-layered substrate SB1, thereby forming a sixth capacitance between them. Namely, the sixth capacitance is formed by an electromagnetic coupling between the inductor 14 and the second conductive pattern 52. The second capacitor 15 has the fourth, fifth and sixth capacitances. The high frequency filter 9 of FIGS. 10A and 10B can be configured to have the increased capacitance which is higher than the capacitance of the high frequency filter 1 of FIG. 1.

In some cases, the multi-layered substrate SB1 may have two different levels at which the conductors are formed. In other cases, the multi-layered substrate SB1 may be modified to have three or more different levels at which the elements of the high frequency filter are formed. If the multi-layered substrate SB1 has three or more different levels, then it is preferable that the input and output lines are disposed at the surface level and the first and second conductive patterns 51 and 52 are disposed at a level that is closest to the surface level in view of ensuring largest possible capacitance. If the substrate is a single-layered substrate, the input and output lines are disposed at the upper surface level and the first and second conductive patterns are disposed at the lower surface level.

In some cases, the high frequency filter 2 shown in FIG. 4 can be modified by replacing the pair of filtering portions 16 of the high frequency filter 4 shown in FIG. 7A for each of the first, second, third and fourth filtering portions 23, 24, 25, and 26 thereof.

In other cases, the high frequency filter 2 shown in FIG. 4 can be modified by replacing the combination of the filtering portions 16 with the inductive portion 17 of the high frequency filter 5 shown in FIG. 7B for each of the first, second, third and fourth filtering portions 23, 24, 25, and 26 thereof.

In other cases, the high frequency filter 2 shown in FIG. 4 can be modified by replacing the filtering portion 31 of the high frequency filter 6 shown in FIG. 8A for each of the first, second, third and fourth filtering portions 23, 24, 25, and 26 thereof.

In other cases, the high frequency filter 2 shown in FIG. 4 can be modified by replacing the pair of filtering portions 31 of the high frequency filter 7 shown in FIG. 8B for each of the first, second, third and fourth filtering portions 23, 24, 25, and 26 thereof.

In some cases, the high frequency filter 2 shown in FIG. 4 can be modified by replacing the first and second chip capacitors 41 and 42 of the first and second capacitors 13 and 15 of the high frequency filter 8 shown in FIG. 9 for the spatial gaps of the first and second capacitors 13 and 15 thereof.

In other cases, the high frequency filter 2 shown in FIG. 4 can be modified by replacing the first and second conductive patterns 41 and 42 of the first and second capacitors 13 and 15 of the high frequency filter 9 shown in FIG. 10 for the spatial gaps of the first and second capacitors 13 and 15 thereof.

In accordance with the embodiments, the above-described high frequency filters 1 to 9 each use the microstripline. In some cases, the above-described high frequency filters 1 to 9 each may be modified by using either an embedded microstripline or an asymmetric stripline instead of the microstripline. In other cases, the above-described high frequency filters 1 to 9 may be each modified by using either a waveguide or a frequency selective surface instead of the microstripline.

In accordance with the embodiments, the above-described high frequency filters 1 to 9 each have the branch-line or branch-lines that extend in the direction perpendicular to the direction along which the transmission line extends. In some cases, the above-described high frequency filters 1 to 9 each may be modified that the branch line or branch lines are not perpendicular to the transmission line, provided that the branch line or branch lines intersect the transmission line. The above-described high frequency filters 1 to 9 are typical examples that the branch line or branch lines are perpendicular to the transmission line.

As used herein, the following directional terms “forward, rearward, above, downward, vertical, horizontal, below, and transverse” as well as any other similar directional terms refer to those directions of an apparatus equipped with the present invention. Accordingly, these terms, as utilized to describe the present invention should be interpreted relative to an apparatus equipped with the present invention.

The terms of degree such as “substantially,” “about,” and “approximately” as used herein mean a reasonable amount of deviation of the modified term such that the end result is not significantly changed. For example, these terms can be construed as including a deviation of at least ±5 percents of the modified term if this deviation would not negate the meaning of the word it modifies.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A high frequency filter for filtering a frequency component from a high frequency signal, the high frequency filter comprising:
a capacitor disposed in series to a transmission line, the transmission line transmitting the high frequency signal, the capacitor performing as capacitive component to the high frequency signal; and
a branch line that intersects the transmission line, the branch line comprising a capacitive portion and an inductive portion, the capacitive portion performing as capacitive component to the high frequency signal, and the inductive portion performing as inductive component to the high frequency signal.

2. The high frequency filter according to claim 1, wherein the inductive portion of the branch line comprises a first pattern that is narrower in width than the transmission line, the first pattern extends in a cross-direction to the transmission line.

3. The high frequency filter according to claim 2, wherein the capacitive portion of the branch line comprises a second pattern that is wider in width than the first pattern, the second pattern extends in a cross-direction to the transmission line.

4. The high frequency filter according to claim 2, wherein the capacitive portion of the branch line comprises a plurality of third patterns that are electromagnetically coupled to each other, the third patterns extend in a cross-direction to the transmission line.

5. The high frequency filter according to claim 1, wherein the branch line extends from at least one side of the transmission line in a cross-direction to the transmission line.

6. The high frequency filter according to claim 1, further comprising:
an inductor disposed in series to the transmission line, the inductor performing inductive component to the high frequency signal.

7. The high frequency filter according to claim 6, wherein the inductor comprises a fourth pattern that is narrower in width than the transmission line, and the fourth pattern is aligned to the transmission line.

8. The high frequency filter according to claim 7, wherein the branch line extends from the fourth pattern.

9. The high frequency filter according to claim 1, wherein the capacitor comprises a chip capacitor.

10. The high frequency filter according to claim 1, wherein the capacitor comprises a fifth pattern that partially overlaps the transmission line in plan view, and the fifth pattern is electromagnetically coupled to the transmission line to form a capacitive component between the fifth pattern and the transmission line.
